(19) United States
(12) Patent Application Publication
(10) Pub. No.: US 2013/0063517 A1
(43) Pub. Date: Mar. 14, 2013

(54) SOLID PRINTING INK COMPOSITION FOR TEMPORARILY MARKING OPTICAL GLASSES

(71) Applicant: Hans-Joachim Weippert, Aalen (DE)

(72) Inventor: Hans-Joachim Weippert, Aalen (DE)

(73) Assignee: Carl Zeiss Vision International GMBH, Aalen (DE)

(21) Appl. No.: 13/580,752

(22) PCT Filed: Feb. 9, 2011
(86) PCT No.: PCT/EP2011/051912

§ 371 Date: Nov. 5, 2012

(30) Foreign Application Priority Data
Feb. 26, 2010 (DE) 102010009379.3

(51) Int. Cl. C09D 11/10; C09K 11/08; B41J 2/015; C08K 5/12

(52) U.S. Cl. 347/20; 524/299; 524/291; 252/301.36; 101/483

(57) ABSTRACT

The present invention relates to a solid printing ink composition, comprising
at least one organic compound with a melting point of at least 40° C. and a molecular weight of less than 1000 g/mol, wherein the organic compound is selected from an ester, an ether or an amide,
a resin, and
a dye and/or a pigment.

Before being delivered to the optician, spectacle lenses are printed with various markings (e.g. optical axes, etc.). This printing is necessary so that the respective spectacle lenses can be adapted exactly to the customer's sight defects at the opticians during the grinding process. After the adapting operation, it must be possible for the markings to be removed completely without great expense.

A method used at present for printing spectacle lenses is for example pad printing. A drawback of this method is that a separate plate is required for each radius and each stamping pattern. In the past there have therefore been various attempts to replace the very expensive pad printing technique with other more flexible methods, e.g. using an inkjet printer.

An inkjet process, using a paraffin-based wax, is also known in the marking of packing units. The wax is melted by heating to >70° C. The low-viscosity melt is sprayed with a piezoelectric printhead onto the substrate that is to be marked, e.g. a spectacle lens. The wax droplets solidify immediately after reaching the substrate surface. A substantial drawback of these waxes as marking material for spectacle lenses is the inadequate removability, largely caused by the poor dissolution behaviour of paraffins and comparable waxes (montan waxes, stearin waxes, beeswax etc.).

Printing inks based on hot melt adhesive preparations or wax mixtures are described in U.S.2003/0127021 A1. The “hot melt inks” described can contain waxes, resins, polymers, plasticizers, antioxidants, pigments and dispersing agents as possible components. They are applied on the substrates by inkjet printers, e.g. MARKEM MODEL 5000. Owing to the aforementioned possible ingredients, easy and residue-free removability from optical surfaces such as spectacle lenses is not provided by these inks.

DE 10 2005 021 654 A1 describes a method in which spectacle lenses are printed by means of an inkjet process with an ethanol-containing ink. In the case of hydrophobized surfaces (e.g. Lotu-Tec coating), with solvent-containing printing inks problems easily arise through shrinkage of the printed image during the venting operation (solvent evaporation). Moreover, solvent-containing printing inks have a tendency to leave behind faint images, termed “ghosting”, on the lens surface, caused by penetration of solvent-soluble components of the printing inks into the antireflection coating of the spectacle lenses (affecting the optical properties of the coating). DE 10 2005 021 654 A1 attempts to solve this problem by greatly speeding up the venting operation using infrared radiation or warm air.

For developing a solid, wax-like printing ink that can be applied by means of inkjet technology on spectacle lenses, the following profile of requirements must be met:
good adhesion to the substrate,
print contours with sharp edges,
no shrinkage of the printed image with Lotu Tec lenses (i.e. with hydrophobized surfaces),
printing that is stable during storage, no detachment or chipping, no adhesion to the packing material of the spectacle lenses,
storage temperature of the printed spectacle lenses approx. −25° C. to +50° C.,
water-insoluble,
no ghosting effect after storage time of the printed spectacle lenses of up to 6 months (faint image on the lens surface from the printing after removal of the printing ink),
solvent-free,
ageing-resistant,
can be coloured in various colours, preferably yellow and blue, multicolour printing optional,
low-viscosity melt, with stable viscosity, should not foam,
melt should be able to pass through a fine filter (filter fineness 5μ or less),
printing removable (at the opticians) easily and without smearing with alcohols (ethanol, isopropanol), optionally also with acetone,
no harmful ingredients, as far as possible.

One problem to be solved by the present invention is to provide a printing ink composition that can be applied by means of an inkjet process on optical glasses and fulfils as many as possible of the aforementioned requirements, e.g. good substrate adhesion, contours with sharp edges, no shrinkage of the printed image in the case of hydrophobized surfaces, no ghosting effect, and easy removability with alcohols or acetone without smearing.

According to the present invention, this problem is solved by providing a solid printing ink composition, comprising:
at least one organic compound with a melting point of at least 40° C. and a molecular weight of less than 1000 g/mol, wherein the organic compound is selected from the substance class of esters, ethers or amides,
a resin, and
a dye and/or a pigment.

The composition according to the invention can be applied in the molten state by means of inkjet technology on optical glasses such as spectacle lenses. Owing to the rapid solidification of the ink droplets produced in the inkjet process on reaching the spectacle lens surface, shrinkage of the printed image in the case of Lotu Tec lenses is avoided. After printing, the inks can be removed from the spectacle lens surface with alcohols (ethanol, isopropanol) or with acetone, completely and without smearing.

As noted above, the solid printing ink composition comprises at least one organic compound with a melting point of at least 40° C. and a molecular weight of less than 1000 g/mol, wherein the organic compound is selected from the substance class of the esters, ethers or amides. Organic compounds of this substance class are well known by a person skilled in the art and are commercially available or are obtainable by known standard methods of synthesis. Their melting points can be found in the literature.

The organic compound is preferably an aromatic ester, an aromatic amide or an aromatic ether.

In the context of the present invention, aromatic esters, ethers and amides are to be understood as compounds that have, on the one hand, at least one corresponding functional group, thus at least one ester, ether or amide group and moreover contain at least one aromatic group. In the context of the present invention, the term “aromatic group” is used in its usual meaning familiar to a person skilled in the art and therefore comprises a cyclic group with a double bond system fully conjugated via the ring. The aromatic group can be a carbocyclic (i.e. aromatic ring that only has carbon atoms) or heterocyclic aromatic group, a carbocyclic aromatic group being preferred in the context of the present invention. Basically, mononuclear as well as bi- or polynuclear aromatic systems can be used.

With the preferred use of an aromatic ester, ether or amide or a mixture of these aromatic compounds, it has been shown in the context of the present invention that the rapid crystallization of the organic solid when the liquid droplet encounters the surface of the optical glass (e.g. spectacle lens) can be further improved.

In the case of an aromatic ester, the aromatic group can be located in the part of the molecule that is derived from the acid and/or in the part that is derived from the alcohol.

In the case of an aromatic amide, the aromatic group can be located in the part of the molecule that is derived from the acid and/or in the part that is derived from the amine.

In the case of the aromatic ether, the aromatic group can either be located in just one of the alcohol components of the ether compound or alternatively in two or more alcohol components. The term “alcohol component” means a part of the ether compound derived from an alcohol.

The ester, the ether and/or the amide can have just one corresponding functional group or several corresponding functional groups.

The organic compound is preferably an ester, an ether or an amide of an aromatic carboxylic acid and/or of an aromatic alcohol.

In the context of the present invention, the aromatic carboxylic acid can be an aromatic monocarboxylic acid, an aromatic dicarboxylic acid, an aromatic tricarboxylic acid or a mixture of these compounds.

The aromatic monocarboxylic acid is preferably a substituted or unsubstituted benzoic acid.

The aromatic dicarboxylic acid is preferably a substituted or unsubstituted terephthalic acid, a substituted or unsubstituted isophthalic acid, a substituted or unsubstituted phthalic acid, or a mixture of these compounds.

As preferred aromatic tricarboxylic acid, we may mention for example a substituted or unsubstituted trimesic acid, a substituted or unsubstituted trimellitic acid, or a mixture of these compounds.

The aromatic alcohol is preferably a substituted or unsubstituted monovalent, divalent or trivalent phenol or a mixture of these compounds.

As examples of monovalent, divalent and trivalent phenols, we may mention phenol, 1,2-dihydroxybenzene(pyrocatechol), 1,3-dihydroxybenzene(resorcinol), 1,4-dihydroxybenzene(hydroquinone), 1,2,3-trihydroxybenzene(pyrogallol), 1,3,5-trihydroxybenzene(phloroglucin), and these phenols can be substituted or unsubstituted.

If the aforementioned aromatic carboxylic acids or alcohols are substituted, they can be e.g. alkyl, preferably C₁₋₄-alkyl, aryl, preferably phenyl, which in their turn can be substituted again. The aromatic carboxylic acids or alcohols can, however, also be substituted with further polar groups, e.g. hydroxyl groups. Through appropriate selection of substituents, it is possible to influence the melting point and the crystallization behaviour of the organic solid.

The aromatic mono-, di- or tricarboxylic acid described above can be esterified with a monovalent or polyvalent (preferably di- or trivalent) alkyl alcohol, cycloalkyl alcohol, aryl alcohol (preferably a phenol, as already described above) or a mixture of these alcohols.

Examples of benzoic acid esters that can be used in the context of the present invention are e.g. glyceryl tribenzoate (m.p.=71° C.), neopentylglycol dibenzoate (m.p.=49° C.), 1,4-cyclohexanedimethanol dibenzoate (m.p.=118° C.), phenylbenzoate (m.p.=66-69° C.), 3-hydroxyphenylbenzoate (m.p.=133° C.), resorcinol monobenzoate (m.p.=133-141° C.), resorcinol dibenzoate.

Examples of terephthalic acid esters that can be used in the context of the present invention are e.g. bis(2-hydroxyethyl)terephthalate (m.p.=106-109° C.), dimethyl terephthalate (m.p.=139-141° C.)

Examples of isophthalic acid esters that can be used in the context of the present invention are e.g. isophthalic acid dimethyl ester (m.p.=64-68° C.), isophthalic acid monomethyl ester (m.p.=194-196° C.), isophthalic acid diphenyl ester (m.p.=136-138° C.)

For example dicyclohexylphthalate (m.p.=63-65° C.) can be used as phthalic acid ester.

As suitable trimesic acid esters (1,3,5-tricarboxylic acid) we may mention for example trimesic acid trimethyl ester (m.p.=145-147° C.) and trimesic acid triethyl ester (m.p.=134-139° C.).

The aromatic amide can be obtainable by reaction of the aforementioned aromatic mono-, di- or tricarboxylic acid with NH₃, a primary, secondary and/or tertiary amine. The primary, secondary or tertiary amines can have alkyl, preferably C₁₋₄-alkyl, cycloalkyl e.g. cyclohexyl, and/or aryl e.g. phenyl residues. As an example of aromatic amide, we may mention dimethylbenzamide (m.p.=43-45° C.)

The aromatic alcohol defined above can be etherified with a further alcohol to the aromatic ether. As a suitable further alcohol, with which the reaction to aromatic ether takes place, it is possible to use a monovalent or polyvalent (preferably di- or trivalent) alkyl alcohol, cycloalkyl alcohol, aryl alcohol (preferably one of the phenols already described above) or a mixture of these alcohols.

Examples of aromatic ethers that can be used in the context of the present invention are e.g. 1,4-dimethoxybenzene (m.p.=54-56° C.), resorcinol diphenyl ether (m.p.=59-61° C.), ethylene glycol diphenyl ether (m.p.=94-96° C.), phenylethylene glycol (m.p.=66-68° C.), or mixtures thereof.

In the context of the present invention, the aromatic alcohol defined above can also be reacted with an inorganic acid, e.g. phosphoric acid, to an aromatic ester. For example, in this connection we may mention an aryl phosphate, preferably a triaryl phosphate, e.g. triphenyl phosphate (m.p.=47-53° C.)

In a preferred embodiment, the organic compound has a 1,4-disubstituted cyclohexane or benzene unit and each of the two substituents, which are preferably identical, contains an ester, amide or ether group. Examples of organic compounds that may be mentioned in this connection are esters of terephthalic acid, or also 1,4-cyclohexanediol dicarboxylates, e.g. 1,4-cyclohexanedimethanol dibenzoate. In the context of the present invention, it has been found that linear molecular structures, e.g. 1,4-disubstituted aromatics, recrystallize particularly easily from the melt.

Preferably the organic compound described above has a melting point of 250° C. or less, more preferably a melting point of 200° C. or less.

In the context of the present invention, the solid printing ink composition can contain just one of the organic compounds described above or alternatively a mixture of two or more of these organic compounds. By using suitable mixtures of these organic compounds it is possible to influence the crystallization behaviour in a targeted manner. It is possible for the mixture to have two or more of the esters described above (preferably aromatic esters) and/or two or more of the ethers described above (preferably aromatic ethers) and/or two or more of the amides described above (preferably aromatic amides). In the context of the present invention it is, however, also possible for the mixture to have for example an ester in combination with an ether or an ester in combination with an amide or an ether in combination with an amide.

Preferably, the organic compound or the organic compounds with a melting point of at least 40° C. and a molecular weight of less than 1000 g/mol are present in an amount from 60 wt. % to 98 wt. %, more preferably in an amount from 80 wt. % to 92 wt. %, relative to the total weight of the composition.

As already noted above, the solid printing ink composition according to the invention comprises at least one resin.

Preferably the resin is a non-reactive resin.

As preferred resins, we may mention e.g. colophony derivatives, polyterpene resins, hydrocarbon resins, ketone resins, aldehyde resins, polyvinyl acetates, acrylic and/or methacrylic resins, polyamide resins or mixtures of these resins.

Preferably the resin is present in an amount from 2 wt. % to 40 wt. %, more preferably in an amount from 5 wt. % to 20 wt. %, relative to the total weight of the composition.

As already noted above, the solid printing ink composition according to the invention comprises a dye and/or a pigment.

Preferably the dye or the pigment is selected from metal complex dyes, e.g. Neozapon blue (commercially available from BASF), organic or inorganic pigments, e.g. Light Yellow (Bayer), inorganic fluorescent pigments, e.g. Lumilux Red (Honeywell), or a mixture of these dyes and/or pigments.

Preferably the dye or the pigment is present in an amount from 0.05 wt. % to 5 wt. %, more preferably in an amount from 0.1 wt. % to 2 wt. %, relative to the total weight of the composition.

The composition can further comprise a wetting agent.

For example, fluoro surfactants may be mentioned as wetting agents, e.g. those that are known by the trade name Zonyl®.

Preferably the wetting agent is present in an amount from 0.02 wt. % to 5 wt. %, more preferably in an amount from 0.1 wt. % to 2 wt. %, relative to the total weight of the composition.

In a preferred embodiment, the solid printing ink composition comprises a nucleating agent.

In the context of the present application, the term “nucleating agent” is used in its usual meaning familiar to a person skilled in the art and comprises compounds that function as nucleating agents and hence promote crystallization.

Preferably it is an aromatic nucleating agent, i.e. the nucleating agent contains at least one aromatic group. Regarding the term “aromatic group”, reference may be made to the account given above. The aromatic nucleating agent preferably has a melting point of at least 140° C. More preferably the aromatic nucleating agent has a melting point in the range from 140° C. to 350° C., even more preferably in the range from 200° C. to 300° C.

Preferably the nucleating agent is a compound that has only moderate to low solubility in a melt of the organic compound defined above with a melting point of at least 40° C. and a molecular weight of less than 1000 g/mol. Regarding the mode of action of the nucleating agent, the following is presumed: When the molten printing ink composition leaves the printing device, e.g. an inkjet printer, in the form of a liquid drop, there is already notable cooling of the liquid drop in the air before it impinges on the surface of the optical glass. This cooling is already sufficient for initial crystal nuclei of the nucleating agent to form in the liquid drop. When this liquid drop then reaches the surface to be printed, the crystal nuclei of the nucleating agent bring about even faster crystallization of the organic compound defined above.

It has proved advantageous if the organic compound(s) is/are an aromatic ester, an aromatic amide and/or an aromatic ether and the nucleating agent has an aromatic group (i.e. an aromatic nucleating agent). Regarding the term “aromatic group”, reference may be made to the account given above.

In a preferred embodiment, the aromatic nucleating agent is a substituted or unsubstituted anthracene, a substituted or unsubstituted pyrene or a substituted or unsubstituted perylene, or a mixture of these compounds.

Preferably the nucleating agent is present in an amount from 1 wt. % to 6 wt. %, more preferably in an amount from 2 wt. % to 4 wt. %, relative to the total weight of the composition.

Basically, printed spectacle lenses cannot be packed in the usual packaging such as paper bags until the printing has attained sufficient strength. If the spectacle lenses are packed too early, the printed image can smear.

For further acceleration of the entire process (printing+packing), in a preferred embodiment the solid printing ink composition contains a reactive epoxy compound, more preferably a reactive epoxy compound or epoxy resin curable by cationic UV-polymerization, and a hydroxy component. In a preferred embodiment, the hydroxy component is already provided by the organic compound with a melting point of at least 40° C. and a molecular weight of less than 1000 g/mol, i.e. the organic compound has one or more (e.g. two) hydroxyl groups. For example, we may mention bis(2-hydroxyethyl)terephthalate. Alternatively, another compound can be added to the composition as hydroxy component in the form of a solid.

So that the solid printing ink composition after UV curing still dissolves well and completely in acetone, the molar ratio of hydroxyl groups to epoxy groups in the composition is in the range from 2:1 to 4:1. Through the deliberate shortfall of epoxy groups, only oligomeric, but not three-dimensionally crosslinked structures, form during the UV curing, so that there is still sufficient solubility in acetone.

Solids are used as hydroxy components in the sense of the application. As mentioned above, these hydroxy components can already be supplied by the organic compound with a melting point of at least 40° C. and a molecular weight of less than 1000 g/mol. Alternatively, an additional compound can be added as hydroxy component. As preferred hydroxy components, we may mention bis(2-hydroxyethyl)terephthalate and 2,2-dimethyl-1,3-propanediol.

Preferred epoxy compounds are ring-epoxidized cycloaliphatics, for example 3,4-epoxycyclohexylmethyl-3,4-epoxycyclohexane carboxylate (Cyracure UVR-6110, manufacturer: Union Carbide) or bis(3,4-epoxycyclohexyl)adipate (Cyracure UVR-6128).

Triarylsulphonium salts, e.g. Cyracure UVI 6976 or Cyracure UVI 6990, are suitable as UV-initiators.

As the solubility of the epoxy resins in the hydroxy components is temperature-dependent, on rapid cooling from the clear melt (without pigment) of the corresponding solid printing ink composition, rapid clouding is observed owing to the start of crystallization of the hydroxy components, together with a considerable increase in viscosity. This effect clearly counteracts the Lotu-Tec effect. Immediately after UV curing, the printing is so solid that the printed spectacle lenses can be packed directly in paper bags.

The solid printing ink composition can be produced by mixing together the components described above by ordinary methods of mixing that are familiar to a person skilled in the art. It is preferable if a composition is obtained that is as homogeneous as possible.

Preferably, during melting of the solid components, excessive temperatures or overheating are avoided, as otherwise decomposition processes may occur and therefore impairment of quality.

According to another aspect, the present invention relates to a method of printing optical glasses, in particular spectacle lenses, wherein the solid printing ink composition described above is prepared, and the composition is applied by a printing device onto the surface of an optical glass, in particular a spectacle lens.

Preferably, the printing device is one which applies the printing ink composition to the surface to be printed using an inkjet printhead.

Preferably the printing device is an inkjet printer.

According to another aspect, the present invention relates to the use of the solid printing ink composition described above for printing optical glasses, in particular spectacle lenses.

The invention is explained in more detail below, referring to specific examples of use.

### EXAMPLES

### Example 1

92 parts by weight 1,4-cyclohexanedimethanol dibenzoate
8 parts by weight synthetic resin SK (ketone resin)
2 parts by weight Zonyl FSN
1 part by weight Sudan Blue 670
Softening range approx. 120-125° C.

### Example 2

85 parts by weight 1,4-cyclohexanedimethanol dibenzoate
10 parts by weight glyceryl tribenzoate
5 parts by weight synthetic resin SK
1 part by weight Zonyl FSN
0.1 part by weight Neozapon Yellow 157
Softening range approx. 110-115° C.

### Example 3

60 parts by weight bis(hydroxyethyl)terephthalate
30 parts by weight triphenyl phosphate
10 parts by weight synthetic resin SK
0.1 part by weight Neozapon Yellow 157
Softening range approx. 100° C.

### Example 4

70 parts by weight 1,4-cyclohexanedimethanol dibenzoate
20 parts by weight triphenyl phosphate
10 parts by weight synthetic resin SK
0.1 part by weight Neozapon Yellow 157
Softening range approx. 100° C.

### Example 5

75 parts by weight 1,4-cyclohexanedimethanol dibenzoate
15 parts by weight triphenyl phosphate
10 parts by weight synthetic resin SK
0.5 parts by weight Zonyl FSN
0.1 part by weight Neozapon Yellow 157
Softening range approx. 105-110° C.

### Example 6

50 parts by weight 1,4-cyclohexanedimethanol dibenzoate
40 parts by weight bis(hydroxyethyl)terephthalate
10 parts by weight synthetic resin SK
0.5 parts by weight Zonyl FSN
0.1 part by weight Neozapon Yellow 157
Softening range approx. 100-105° C.

### Example 7

58 parts by weight 1,4-cyclohexanedimethanol dibenzoate
42 parts by weight bis(2-hydroxyethyl)terephthalate
12 parts by weight synthetic resin SK
1 part by weight anthracene
0.2 parts by weight Zonyl FSN
0.4 parts by weight Sudan Blue
Softening range approx. 100-105° C.

### Example 8

95 parts by weight 1,4-cyclohexanedimethanol dibenzoate
15 parts by weight synthetic resin SK
5 parts by weight anthracene
0.2 parts by weight Zonyl FSN
0.4 parts by weight Neozapon Yellow 157
Softening range approx. 105-110° C.

The compositions of examples 1-8 described above can be applied in the molten state by means of inkjet technology on optical glasses such as spectacle lenses. When the ink droplets reach the surface of the spectacle lens they display very rapid solidification.

Owing to this rapid solidification process on reaching the lens surface, shrinkage of the printed image is avoided even in the case of glasses with hydrophobized surface (Lotu-Tec glasses). Furthermore, after printing, the inks can be removed with alcohols (ethanol, isopropanol) or with acetone completely and without smearing from the spectacle lens surface.

The compositions of examples 7 and 8 additionally contained a nucleating agent, so that the solidification process of the liquid drop on the spectacle lens surface was even quicker. In the case of Lotu-Tec glasses, for liquid droplets that reach the surface, rapid shrinkage is observed. This undesirable property for the printing of spectacle lenses tends to be counteracted if the liquid drop solidifies rapidly or quickly assumes a high viscosity.

1. A solid printing ink composition, comprising:
at least one organic compound with a melting point of at least 40° C. and a molecular weight of less than 1000 g/mol, wherein the organic compound is selected from an ester, an ether or an amide;
a resin; and
a dye, a pigment, or a dye and a pigment.

2. The solid printing ink composition of according to claim 1, wherein the organic compound comprises an organic compound chosen from the group consisting from an aromatic ester; an aromatic amide; and an aromatic ether.

3. The solid printing ink composition of according to claim 1, wherein the organic compound comprises an organic compound chosen from the group consisting of an ester; an ether or an amide of an aromatic carboxylic acid; and an aromatic alcohol.

4. The solid printing ink composition of claim 3, wherein the aromatic carboxylic acid comprises an aromatic carboxylic acid chosen from the group consisting of an aromatic monocarboxylic acid; an aromatic dicarboxylic acid; an aromatic tricarboxylic acid and mixtures of these compounds.

5. The solid printing ink composition of claim 4, wherein the aromatic carboxylic acid is an aromatic carboxylic chosen from the group consisting of an aromatic monocarboxylic acid that is a substituted or unsubstituted benzoic acid.

6. The solid printing ink composition of claim 4, wherein the aromatic carboxylic acid is an aromatic carboxylic chosen from the group consisting of an aromatic dicarboxylic acid that is a substituted or unsubstituted terephthalic acid; substituted or unsubstituted isophthalic acid; a substituted or unsubstituted phthalic acid; and a mixture of these compounds.

7. The solid printing ink composition of claim 4, wherein the aromatic carboxylic acid is a tricarboxylic acid chosen from the group consisting of a tricarboxylic acid that is a substituted or unsubstituted trimesic acid; a substituted or unsubstituted trimellitic acid; and mixtures of these compounds.

8. The solid printing ink composition of claim 3, wherein the aromatic alcohol is chosen from the group consisting of a substituted monovalent phenol, a substituted divalent phenol, a substituted trivalent phenol, an unsubstituted monovalent phenol, an unsubstituted divalent phenol, an unsubstituted trivalent phenol, and mixtures of these compounds.

9. The solid printing ink composition of claim 1, wherein the at least one organic compound is present in an amount from 60 wt. % to 98 wt. %, relative to the total weight of the composition.

10. The solid printing ink composition of claim 1, wherein the resin comprises a resin chosen from the group consisting of: colophony derivatives, polyterpene resins, hydrocarbon resins, ketone resins, aldehyde resins, polyvinyl acetates, acrylic, resins, methacrylic resins, polyamide resins or mixtures of these resins, and wherein the resin is present in an amount from 2 wt. % to 40 wt. %, relative to the total weight of the composition.

11. The solid printing ink composition of claim 1, wherein the dye, if present, is a metal complex dye, and the pigment, if present, is a pigment chosen from the group consisting of: organic pigments, inorganic pigments, inorganic fluorescent pigments, and wherein the dye, the pigment or the mixture of dye and pigment is present in an amount from 0.05 wt. % to 5 wt. %, relative to the total weight of the composition.

12. The solid printing ink composition of claim 1 further comprising a nucleating agent, wherein the nucleating agent is an aromatic nucleating agent, and wherein the nucleating agent is preferably present in an amount from 1 wt. % to 6 wt. %, relative to the total weight of the composition.

13. The solid printing ink composition of claim 1 further comprising a reactive epoxy compound and a hydroxy component, wherein the hydroxy component is supplied by (1) the organic compound with the melting point of at least 40° C. and the molecular weight of less than 1000 g/mol; (2) by a compound added additionally or both, and wherein the molar ratio of hydroxyl groups to epoxy groups in the composition is in the range from 2:1 to 4:1.

14. A method of printing optical glasses comprising the following steps: preparing the solid printing ink composition according to claim 1;
applying the composition using a printing device onto the surface of an optical glass.

15. (canceled)

16. The solid printing ink composition of claim 4, wherein the aromatic alcohol is chosen from the group consisting of a substituted monovalent phenol, a substituted divalent phenol, a substituted trivalent phenol, an unsubstituted monovalent phenol, an unsubstituted divalent phenol, an unsubstituted trivalent phenol, and mixtures of these compounds.

17. The solid printing ink composition of claim 5, wherein the aromatic alcohol is chosen from the group consisting of a substituted monovalent phenol, a substituted divalent phenol, a substituted trivalent phenol, an unsubstituted monovalent phenol, an unsubstituted divalent phenol, an unsubstituted trivalent phenol, and mixtures of these compounds.

18. The solid printing ink composition of claim 6, wherein the aromatic alcohol is chosen from the group consisting of a substituted monovalent phenol, a substituted divalent phenol, a substituted trivalent phenol, an unsubstituted monovalent phenol, an unsubstituted divalent phenol, an unsubstituted trivalent phenol, and mixtures of these compounds.

19. The solid printing ink composition of claim 7, wherein the aromatic alcohol is chosen from the group consisting of a substituted monovalent phenol, a substituted divalent phenol, a substituted trivalent phenol, an unsubstituted monovalent phenol, an unsubstituted divalent phenol, an unsubstituted trivalent phenol, and mixtures of these compounds.

20. The composition of claim 1, wherein the resin is present in an amount from 2 wt. % to 40 wt. %, relative to the total weight of the composition and wherein the solid printing ink composition further comprises a nucleating agent, a reactive epoxy compound and a hydroxyl component and wherein the at least one organic compound is present in an amount from 60 wt. % to 98 wt. %, relative to the total weight of the composition.

21. The method of claim 14, wherein the optical glass is a spectacle lens and the printing device is an inkjet printer.
